(19) United States
(12) Patent Application Publication
(10) Pub. No.: US 2021/0191827 A1
(43) Pub. Date: Jun. 24, 2021

(54) SYSTEM AND METHOD FOR COLLABORATIVE TASK OFFLOADING AUTOMATION IN SMART CONTAINERS

(71) Applicant: Telefonaktiebolaget LM Ericsson (pub!), Stockholm (SE)

(72) Inventors: Senthamiz Selvi ARUMUGAM, Solna (SE); Sambit NAYAK, Bhubaneswar (IN); Saravanan M., Chennai (IN); An kit JAUHARI, Bangalore (IN)

(73) Assignee: Teiefonaktiebolaget LM Ericsson (pub!), Stockholm (SE)

(21) Appl. No.: 17/271,312

(22) PCT Filed: Aug. 30, 2018
(86) PCT No.: PCT/IN2018/050559

§ 371 Date: Feb. 25, 2021

(51) Int. Cl. G06F 11/20; G06F 16/23; G06F 9/48; G06Q 50/18

(52) U.S. Cl. CPC G06F 11/2025; G06F 16/2379; G06F 2201/85; G06Q 50/18; G06F 9/4856

(57) ABSTRACT

A method is provided including receiving a first and second registration requests transmitted by a first and second smart containers, including first and second information identifying a first and second capabilities; and receiving a first request transmitted by the first smart container as a result of a failure experienced by the first smart container, identifying a temporary capability. The method further includes, as a result of receiving the first request, determining that the second smart container can perform the temporary capability. The method further includes sending a second request to the second smart container, asking the second container to perform the temporary capability; receiving an acknowledgement message transmitted by the second smart container indicating that the second smart container accepts the second request; and, upon receiving the acknowledgement message transmitted by the second smart container, establishing a smart contract between the first smart container and the second smart container.

### TECHNICAL FIELD

Disclosed are embodiments related to task offloading automation.

### BACKGROUND

Connected logistics is a new paradigm which involves interdependent sets of communication devices, protocols, and Internet-of-Things (IoT) technologies that change key logistical processes to become more customer-centric. Connected logistics is based on sharing data, information, and facts with supply chain partners during transportation using smart containers. The market for connected logistics is still in the introductory stage. However, even at this introductory stage, the market includes interconnected devices that providers of logistics and IoT solutions use for getting more visibility within warehouse, transportation, and associated logistics processes, such as order processing, financial transactions, shipping, and dispatch and packing. Connected logistics helps to drive more effective business decisions by identifying crucial bottlenecks and, therefore, it facilitates smooth decision making.

Though the concept of connected logistics is still new, it is expected to generate new waves in the coming years with advanced technologies. Connected logistics solutions depend on new and disruptive technologies such as smart containers and block-chain-based security. With these technologies, IoT-based solutions automate the use of data generated by non-traditional end-point devices and have been successfully implemented in smart cities for various purposes related to smart transportation and manufacturing. Most IoT solutions face challenges when it comes to security. Therefore, addressing security aspects of an IoT solution is valuable for industry development.

### SUMMARY

Smart containers involved in modern Supply Chain Management (SCM) are equipped with certain capabilities such as controlled environments (e.g., refrigeration to control temperature, humidity controls to control humidity) for maintaining the integrity of the goods they transport by using IoT devices and sensors. There are situations in SCM where re-planning or contingency routing of transport is needed, such as for failure of environment controls in a container, or a breakdown or other failure. To handle these situations, therefore, a dynamic adaptation for exchange of goods with similarly capable smart containers is needed. Smart containers need to collaborate in such situations and provide dynamic adaptability to mitigate problems that are encountered.

In the prior art, such contingency planning, if it happens at all, is carried out manually between different parties collaborating to exchange information and plan for alternatives (such as task-offload), which increases the lead time to delivery. This planning for alternatives is manual in the sense that a party will assign another truck from his fleet or may seek a third party vendor's resource to fulfill a need. In cases where the party needs to seek help from a third party logistics provider (3PLP), the party needs to establish a contract and agree to terms manually, which further increases the lead time to delivery. At times, such as when delivery of goods is critical (e.g., transport of pharmaceuticals or medicine where time is critical), the need for arranging for alternatives is of utmost importance. Other problems include theft, suspicious activities, and fraud e.g. to manipulate such smart containers, since security is still a challenge when it comes to IoT solutions. Automating the SCM process by addressing the security challenges is a prime concern in Connected Logistics. Embodiments described herein address these and other issues.

Smart Containers need to have a solution for such failure scenarios to perform collaborative or incentivized task off-load/sharing through a secure and automated system that is auditable, in-order to effectively carry out large scale automated processes in SCM. There is a need for secure collaboration with other nearby smart containers for mitigating problems due to anomalies like breakdown of machinery or incapacitation of the container itself, all of which may jeopardize the quality of the goods being transported.

Effectively dealing with contingency planning efficiently and in a business acceptable manner can be very important in industry. In the example above, for instance, involving delivery of critical goods such as medicine, obviously a failure to deliver within time constraints can have adverse consequences. For time- and temperature-sensitive healthcare products, safe delivery is crucial. Problems may also arise when delivering medicine, food, or other perishable goods where, for example, temperature or humidity controls break down. Such medicine, food, or other perishable goods may lose their value, or even become unsafe to consume. Beyond the immediate problems of failing to deliver goods on time, or that are of acceptable quality, companies may face consequences for their reputation, their brand loyalty, and bottom line, especially if such failures are not detected until after consumption.

Embodiments provided herein can help to speed up logistics, minimize discrepancies, create potential cost savings from streamlined processes, improve product visibility, and add visibility, as products travel through a supply chain, as well as otherwise address the above described problem of collaborative/incentivized task off-load/sharing among smart containers. Embodiments also address security concerns, such as through Authentication, Authorization, and Accounting (AAA).

According to a first aspect, a method is provided. The method includes receiving a first registration request transmitted by a first smart container, the first registration request including first information identifying a first capability of the first smart container. The method further includes receiving a second registration request transmitted by a second smart container, the second registration request including second information identifying a second capability of the second smart container. The method further includes receiving a first request transmitted by the first smart container as a result of a failure experienced by the first smart container, the first request including third information identifying a temporary capability. The method further includes, as a result of receiving the first request identifying the temporary capability, determining that the second smart container can perform the temporary capability. The method further includes sending a second request to the second smart container, the second request asking the second smart container to perform the temporary capability. The method further includes receiving an acknowledgement message transmitted by the second smart container indicating that the second smart container accepts the second request; and upon receiving the acknowledgement message transmitted by the second smart container, establishing a smart contract between the first smart container and the second smart container.

According to a second aspect, a method performed by a first smart container is provided. The method includes sending a registration request, the registration request including first information identifying a first capability. The method further includes experiencing a failure; and, as a result of experiencing the failure, sending a first request including second information identifying a temporary capability. The method further includes establishing a smart contract between the first smart container and a second smart container, wherein the second smart container agrees to perform the temporary capability.

According to a third aspect, a method performed by a second smart container is provided. The method includes sending a registration request, the registration request including information identifying a first capability. The method further includes receiving a request to perform a temporary capability; sending an acknowledgement message accepting the request; and establishing a smart contract between a first smart container and the second smart container.

According to a fourth aspect, a device is provided. The device is adapted to receive a first registration request transmitted by a first smart container, the first registration request including first information identifying a first capability of the first smart container; receive a second registration request transmitted by a second smart container, the second registration request including second information identifying a second capability of the second smart container; receive a first request transmitted by the first smart container as a result of a failure experienced by the first smart container, the first request including third information identifying a temporary capability; as a result of receiving the first request identifying the temporary capability, determine that the second smart container can perform the temporary capability; send a second request to the second smart container, the second request asking the second smart container to perform the temporary capability; receive an acknowledgement message transmitted by the second smart container indicating that the second smart container accepts the second request; and upon receiving the acknowledgement message transmitted by the second smart container, establish a smart contract between the first smart container and the second smart container.

According to a fifth aspect, a device is provided. The device is adapted to send a registration request, the registration request including first information identifying a first capability; experience a failure; as a result of experiencing the failure, send a first request including second information identifying a temporary capability; establish a smart contract between the first smart container and a second smart container, wherein the second smart container agrees to perform the temporary capability.

According to a sixth aspect, a device is provided. The device is adapted to send a registration request, the registration request including information identifying a first capability; receive a request to perform a temporary capability; send an acknowledgement message accepting the request; and establish a smart contract between a first smart container and the second smart container.

According to a seventh aspect, a device is provided. The device includes a receiving unit configured to receive a first registration request transmitted by a first smart container, the first registration request including first information identifying a first capability of the first smart container. The receiving unit is further configured to receive a second registration request transmitted by a second smart container, the second registration request including second information identifying a second capability of the second smart container. The receiving unit is further configured to receive a first request transmitted by the first smart container as a result of a failure experienced by the first smart container, the first request including third information identifying a temporary capability. The device further includes a determining unit configured, as a result of the receiving unit receiving the first request identifying the temporary capability, to determine that the second smart container can perform the temporary capability. The device further includes a sending unit configured to send a second request to the second smart container, the second request asking the second smart container to perform the temporary capability. The receiving unit is further configured to receive an acknowledgement message transmitted by the second smart container indicating that the second smart container accepts the second request. The device further includes an establishing unit configured, upon the receiving unit receiving the acknowledgement message transmitted by the second smart container, to establish a smart contract between the first smart container and the second smart container.

According to an eighth aspect, a device is provided. The device includes a sending unit configured to send a registration request, the registration request including first information identifying a first capability. The sending unit is further configured, as a result of experiencing a failure, to send a first request including second information identifying a temporary capability. The device further includes an establishing unit configured to establish a smart contract between the first smart container and a second smart container, wherein the second smart container agrees to perform the temporary capability.

According to a ninth aspect, a device is provided. The device includes a sending unit configured to send a registration request, the registration request including information identifying a first capability. The device further includes a receiving unit configured to receive a request to perform a temporary capability. The sending unit is further configured to send an acknowledgement message accepting the request. The device further includes an establishing unit configured to establish a smart contract between a first smart container and the second smart container.

According to a tenth aspect, a computer program is provided. The computer program includes instructions which, when executed on at least one processor, causes the at least one processor to carry out the method according to any one of the first, second, and third aspects.

According to an eleventh aspect, a carrier is provided. The carrier includes the computer program of the tenth aspect, wherein the carrier is one of an electronic signal, optical signal, radio signal or computer readable storage medium.

Advantages, which are applicable to any of the above-described aspects, include the following: Providing an automated solution for task sharing among smart containers in SCM systems. Providing security, reliability, and auditability features to SCM systems (such as by use of smart contracts on block chains). Providing a reduction of waste, valuable resources, operational costs, monies saved for insurances, and accountability to SCM systems. Providing for maintaining the integrity of goods transported by smart containers in SCM systems. Providing highly effective and optimal resource planning in SCM systems. Providing insights into real causes of waste, loss, and other metrics in SCM systems. Providing highly valuable solutions for solving smart cities' transportation and logistics problems. Providing incentivization to motivate smart containers (and their owning parties) to participate in task sharing and fulfilment. Providing for improved quality of customer experience and improved accuracy of operations in SCM systems.

### BRIEF DESCRIPTION OF THE DRAWINGS

The accompanying drawings, which are incorporated herein and form part of the specification, illustrate various embodiments.

FIG. 1 illustrates an SCM system according to one embodiment.

FIG. 2 illustrates a flow chart according to one embodiment.

FIG. 3 illustrates a message diagram according to one embodiment.

FIG. 4 is a flow chart illustrating a process according to one embodiment.

FIG. 5 is a flow chart illustrating a process according to one embodiment.

FIG. 6 is a flow chart illustrating a process according to one embodiment.

FIG. 7 is a diagram showing functional units of a node according to one embodiment.

FIG. 8 is a block diagram of a node according to one embodiment.

### DETAILED DESCRIPTION

A SCM process involves various activities to transport goods from a point of origin to a point of consumption. The process may include design, planning, execution, control, and monitoring of the supply-chain activities. Traditionally, the various parties involved across the supply chain have their own Enterprise Resource Planning systems, or manual systems, to carry out their respective functions. In addition, each element of the SCM follows different processes—bridged by paper—based on disparate digital systems with little or no standards for interoperability. Smart containers may be used which provide for traceability and transparency features desired by modern SCM systems. These smart containers may come equipped with IoT devices, sensors, radio-frequency identifiers (RFIDs), and so forth, which can aid in providing real-time data about the conditions in and around the smart containers. This functionality may also enable accountability among the different parties involved in the SCM process. Such accountability can be further augmented with the use of block-chain-enabled smart contracts, which can provide precise data for validating the accountability of each party and also can help in expediting payments across the supply chain process.

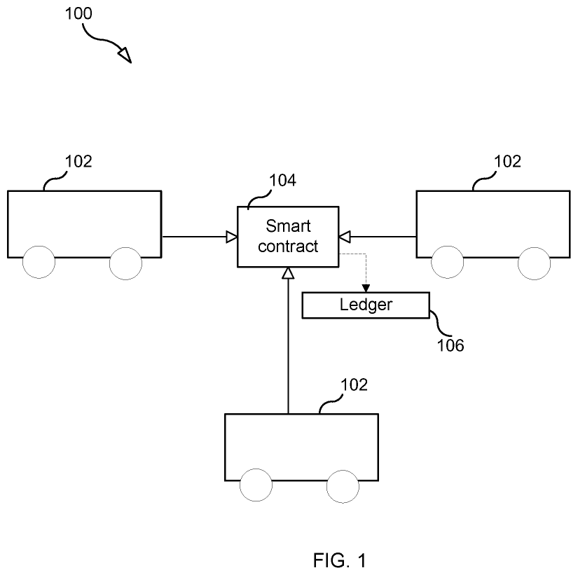

FIG. 1 illustrates a system according to one embodiment. SCM system 100 includes multiple smart containers 102 communicatively coupled to a node 104. Node 104 may itself be a smart contract, or may be a proxy for connecting to a smart contract. Node 104 has access to a ledger 106, such as a block chain ledger. Node 104 and ledger 106 may reside together, or in close proximity to each other, or may be geographically spaced apart. For example, ledger 106 may be implemented in a cloud computing environment that is remote from node 104. Smart containers 102 may register capabilities, request for task offload, accept offloaded tasks (with or without incentivation and bids), and register completion of a task securely via node 104. Capabilities may include temperature or humidity control. A request for task offload may arise due to a failure in the smart container, such as a failure to maintain one of its capabilities. The task offload requested may include e.g. physical offload of goods such as from a truck. In such a case, the completion of a task may include when the physical offload of goods is completed, such that the goods are offloaded from one truck and then loaded onto another truck, having the appropriate capabilities.

In embodiments of SCM system 100, a requester smart container 102 desiring to perform a task off-load sends a request to smart contracts on the block chain (such as via node 104) for a set of required capabilities, and a suitable provider smart container 102 is then selected. For example, a required capability may include the ability to control temperature within a set of temperature control parameters. In some embodiments, the selection of a suitable provider smart container may involve some form of incentivization. Overall, an agreement is crafted between the provider and the requester smart containers 102, and external triggers are generated for the transfer of the task/load between such authorized smart containers 102 (e.g. for manual or automated transfer between the smart containers of a transported load such as medicine or food). If the goals of the smart containers 102 are themselves tracked on the block chain, then the completion of the offloaded task/load may also be made accountable on the block chain through codified logic. All the above logic actions may be codified as smart contracts on the block chain.

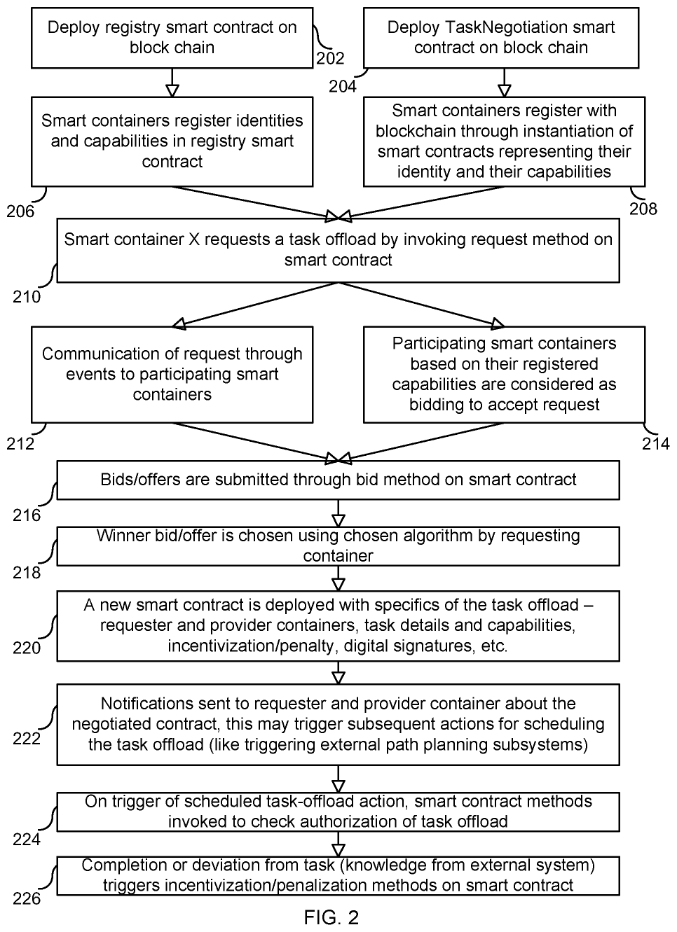

The use of a block-chain-enabled smart contract with respect to embodiments of system 100 is now described, in relation with FIG. 2.

The smart containers 102 have access rights to operate on a block chain, such as ledger 106 (either directly or indirectly). Note that there are certain variations possible on the aspects of deployment of the block chain.

One possibility is to have the smart containers 102 run a block chain using their on-board computation capability. The other is to have a set of servers operating the block chain (e.g., in-house by one or more governing operator entities, or using cloud-based block chain as-a-service), in which case the smart containers 102 interact with the smart contracts on the block chain through the set of servers operating the block chain.

Depending on the scenario and deployment model, the block chain could be a permissioned one or not. If the smart containers 102 themselves operate the block chain, it could be a permissioned one where an operator (human or software) enlists a newly deployed/commissioned smart container 102 into the set of permissioned nodes for the block chain. Or, in a non-permissioned scenario, any smart container 102 can participate in the running block chain by joining the chain network. If a set of servers are running the block chain, it is likely to be a permissioned model.

A registry smart contract may be deployed on the block chain (see block 202). In such a case, smart containers register their identities and capabilities in the registry smart contract (see block 206). It acts as a repository of smart containers 102 who wish to utilize this application and their registered capabilities (such as temperature control, humidity control, and so forth). Where a registry smart contract is used, the negotiation methods (e.g. request and offer) explained below are modeled as methods on the registry smart contract. In some embodiments, instead of having such a common registry smart contract, each container and their corresponding capabilities may be modeled as an individual smart contract on the block chain. In this case, the negotiation methods (e.g. request and offer) may be modeled as methods on a separate smart contract, which is referred to here as a TaskNegotiation smart contract (see block 204). Further, smart containers register with the block chain through instantiation of smart contracts representing their identity and their capabilities (see block 208).

Each kind of supported smart-container capability may be modeled as a type (such as a struct type) depending on the smart contract language used for the smart contract implementation. Every smart container 102 registers its own capabilities according to such models into the registry smart contract or other individual smart contract, as described above, and updates their capabilities dynamically.

When a smart container 102 wants to off-load a task—such as one or more specific items, or its entire load—it triggers a request method on the appropriate smart contract (see block 210). The task offload request is either a method on the registry smart contract or the TaskNegotiation contract as described above. The task offload request parameters contain information identifying the capability that is being requested, including the specific parameters for such capability (e.g., specific maximum temperature that the temperature control must maintain). Additionally, the task offload request parameters can contain information indicating the basis to accept an offer from among multiple offers, e.g. the parameters may include information indicating that the closest geographical container should be selected (other possible algorithms are described below).

In embodiments, one variation is to not have the capabilities recorded on the block chain, but rather to broadcast requests for requested capabilities out of the block chain, such as through block chain events (see block 212). In such embodiments, the individual smart containers 102 may listen for such events and choose whether or not to offer/bid for each request based on their own capability. If a smart container 102 decides to offer/bid for a given request, it may invoke code on the block chain to actually register its bid/interest to offer service. Penalization schemes (such as currency payouts) for violation of an accepted contract may, in some embodiments, act as a deterrent (e.g. deterring smart containers 102 from accepting bids they have no intention to carry out), or at the very least, the offer/bid sent by the container to the block chain would act as audit information.

In another embodiment, the code in the appropriate smart contract (e.g., registry smart contract or TaskNegotiation smart contract) triggered by the task offload request identifies all available smart containers 102 with matching capability as potential bidders or service providers (see block 214). That is, in this embodiment, the smart containers 102 do not individually choose to bid, but are presumed to bid based on their matching capabilities.

Bids/offers are submitted through a bid method on the appropriate smart contract (see block 216). In embodiments, this bid method may be invoked directly by the smart container 102, or on behalf of the smart container 102 by the smart contract if the smart contract presumes the smart container 102 to be bidding based on its registered capabilities.

On completion of the bidding process, code on the appropriate smart contract (e.g. registry smart contract or TaskNegotiation smart contract) triggers to decide which bid/offer to choose. The logic used to decide which bid/offer to choose may be based on first-come-first-served, i.e. the first bid/offer that has the appropriately matched capability is chosen. Other algorithms, as described below, are also possible. Further, in some embodiments, the task offload request may include a parameter identifying a selection algorithm. Further examples of a selection algorithm include nearest-location, lowest-bid, common-operator, and max-path-alignment, which are described below:

nearest-location: If the smart containers 102 register and update their location in their registered information in the block chain (e.g., registry), the nearest-location algorithm selects the (geographically) nearest located smart container 102 among the smart containers 102 that offer to provide service for the off-loaded task. Such implementation can make use of an external location/mapping service. In some embodiments, “nearest” may be measured by geographic distance, or may be a measure of estimated time to arrive at the location, based on e.g. conditions of roadways, railways, or other mode of transport. For example, if a sensitive pharmaceutical or medicine is being transported, and temperature controls have failed, then the requesting smart container 102 may indicate the nearest-location algorithm, because time is critical to maintaining the quality of the given pharmaceutical or medicine.

lowest-bid: If the implementation allows incentivization for task-offload (such as by payment of fiat/crypto-currency or credit transfer between smart containers 102 or their governing parties, e.g. where different operators/parties are operating smart containers in a common ecosystem), then the bids/offers may include the details of the requested incentive. The lowest-bid algorithm selects the bid/offer that is the lowest (e.g. smallest amount of money).

common-operator: In a deployment involving multiple parties/operators running smart containers 102 in a common ecosystem, the common-operator algorithm selects a target container 102 belonging to the same operator as the requesting container 102, to allow collaboration without incentivization, to reduce costs, or for other reasons.

max-path-alignment: The implementation can use an external path planning or information service. The max-path-alignment algorithm selects a bidding container 102 with the maximum path alignment (or common destination) with respect to the requesting container 102.

One or more of these algorithms, or modified versions of these algorithms, may be used. For example, in one embodiment, the requesting container may specify a threshold geographic area which suitable containers must be within (e.g. within one mile radius), and for any such suitable containers the one with the lowest bid should be selected. Other combinations are also possible. It is also possible for other selection algorithms to be used, such as random selection. The particular algorithm used, which may be based on a parameter from the requesting smart container 102, results in a winning bid/offer, referred to as the target smart container 102 (see block 218).

Once the target smart container 102 is chosen (e.g. as described above), the system 100 records a smart contract containing details about the requesting smart container 102, the smart container 102 that is chosen to take up the task, the capabilities for which such negotiation has happened, and other relevant details such as incentivation/penalty, digital signatures, and so forth (see block 220). Digital signatures from the two participant smart containers 102 in this negotiation can be collected on either the task offload request or the bid/offer, while in other embodiments the digital signatures may be recorded after the details of the negotiated contract are sent to both smart containers 102.

Following negotiation of the contract, notification of such a negotiated contract is sent (e.g. through one or more block chain events) to the participating smart containers 102, so that software running on the smart containers 102 can take subsequent actions, such as scheduling the task-offload (e.g. load transfer) by contacting an external path planning service or non-AI operator (human or software), or by making path adjustments to enable the load transfer (see block 222).

The authentication of smart containers 102 may be done differently based on the deployment model chosen. If the smart containers 102 are participants in the block chain, the authentication system of the block chain implementation based on asymmetric cryptography suffices to allow the smart containers 102 to register on the block-chain-based system and trigger requests and bids. If the smart containers 102 interact with a block chain running on a set of servers, depending on whether the smart containers 102 are registered in the registry smart contract or individual smart contracts as described above, and depending on the smart contract that embodies the task offload negotiation, the smart containers 102 would authenticate with the block-chain-based system by providing their credentials (e.g. asymmetric crypto-key based credentials) to such smart contracts. Authentication is also useful during the exact task/mechanics of task-offload when the smart containers 102 authenticate with the block chain and request to check whether the task-offload is authorized or not.

The negotiated smart contract functions as a record of authorization of a task-offload agreement between two participating smart containers 102. Depending on the exact methodology of how the task-offload happens (e.g., scheduled actions when the smart containers 102 arrive at a common path location, or the smart containers 102 adjust paths to congregate), at the time of the actual task-offload (whether human-assisted or autonomous), a check method is triggered on the block chain to verify whether the participating smart containers 102 do have a valid smart contract for task-offload, and if so, whether such task-offload is allowed (see block 224).

Accounting may take several forms. In some embodiments, there may be incentivization and/or penalization schemes for task-offload. In embodiments, there may also be a rating system for the participating smart containers 102 (or their governing operators), e.g. to rate the smart containers 102 based on their completion of off-loaded tasks. Completion of off-loaded tasks depends upon the nature of the specific task. For example, the delivery of a load by a smart container 102 at a destination point may trigger a completion event, which may trigger a smart-contract based application that manages the tracking of each task's allotment and completion by smart containers 102. Upon either completion or deviation from a task offload request, the incentivization/penalization methods on the smart contract may be triggered (see block 226).

Embodiments of system 100 may be employed in a variety of different uses, and having differing architectures. Some of these variations have been described above. Two different scenarios are described below in more detail.

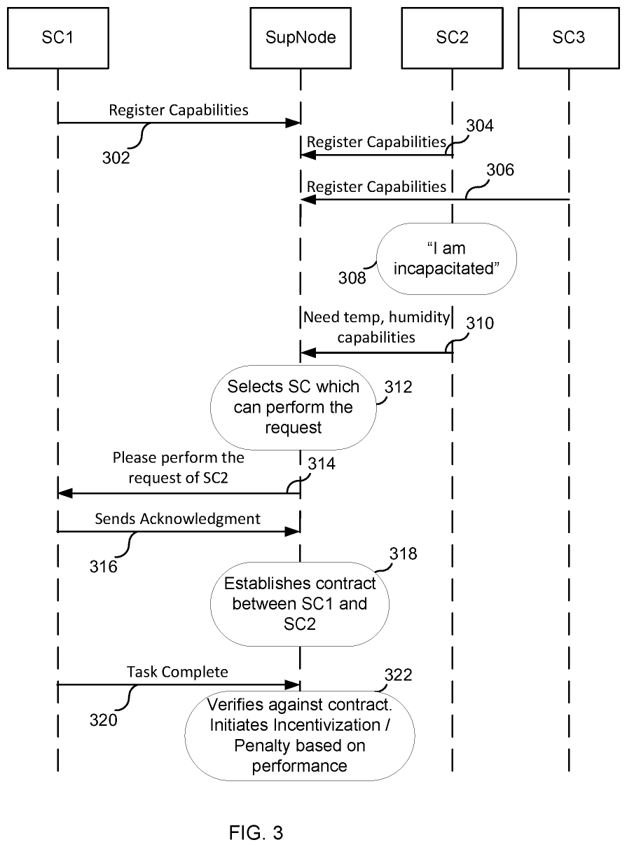

FIG. 3 illustrates a message diagram between three smart containers 102, labeled as SC1, SC2, and SC3, and a computing node. In some cases, the smart containers 102 may not have enough computational resources to interact directly with or run the block chain themselves. In such circumstances, it may be advantageous to provide a set of servers, such as edge/fog compute nodes (referred to as a “SupNode” here and in FIG. 3), throughout the coverage area of the smart containers 102. The SupNode may have more computational resources than the smart containers 102, and may be used to interact with the block chain and the smart contracts that are deployed on the block chain (or ledger). Such a SupNode or SupNodes could be owned by any of the parties involved in this deployment (e.g., logistics companies, operators) or by a solution provider (e.g., such as an edge cloud solution infrastructure provider).

In embodiments, the block chain could be a block-chain-as-a-service implementation (e.g., on a cloud), or a permissioned block chain operated among SupNodes or data centers of parties involved, or a public block chain, or combinations of any of these.

The software for the solution, that is, the business logic, that interacts with the smart contracts on the block chain could be running on the smart containers 102. The smart containers 102 may have limited computational capabilities comparable to a RaspberryPi, for instance. In other embodiments, the business logic that interacts with the smart contracts on the block chain could be running on gateways or SupNodes that are reading the sensors from minimalist smart containers 102 that only have on-board data sensing capabilities (e.g., environment monitoring in the container).

In embodiments, the SupNodes may perform smart contract method invocations on the block chain implementation at the behest of the above software.

As shown, SC1, SC2, and SC3 each register their capabilities with and identify themselves to SupNode (302, 304, 306 respectively). Sometime later, SC2 experiences a failure whereby it becomes unable to complete its currently designated task (308). As a result of this failure, SC2 informs SupNode that it needs a temporary capability in order to compensate for the failure it has experienced (310). As shown, SC2 asks for temperature and humidity capabilities. Following this, there is an offer/bid process (e.g. individual smart containers 102 actively bid, or are presumed to bid based on their registered capabilities), and a target smart container 102 is selected (312). As shown, SC1 is selected. Following selection, SupNode sends a message to SC1 asking it to perform the request of SC2 (314), and SC1 responds back by sending an acknowledgment accepting to perform the request (316). As a result of the acknowledgement, supNode establishes a smart contract between SC1 and SC2 (318). The smart contract ensures that SC1 performs the requested task, and is able to monitor and manage the task. For example, SC1 reports back to SupNode when the task is complete (320), and SupNode then verifies the completion against the smart contract (322). The smart contract and/or the SupNode may initiate appropriate incentivization or penalization based on the task performance. In some cases, SC1 may not report back that the task is complete; instead, the smart contract and/or the SupNode may determine that SC1 has violated performance of the smart contract and invoke appropriate penalization of SC1.

In another deployment architecture, the smart containers 102 may have enough computational resources to interact with the block chain and the smart contracts deployed on it. In such embodiments, the block chain could be running elsewhere, such as in the cloud, as a Decentralized Application (Dapp) on a public ledger like Ethereum, or even on a permissioned ledger among the data centers (or edge compute infrastructure). This kind of deployment hints at more autonomous behavior from the smart containers 102, and is more plausible in future with the current trends of pushing more autonomy and intelligence and computation capabilities to end devices/entities. For example, FIG. 1 illustrates smart containers 102 in communication with a node 104. Node 104 may host one or more smart contracts.

Business logic may be codified in the smart contracts deployed as a Decentralized Application (Dapp) on a block chain. Smart containers 102 can interact with such smart contracts and invoke their methods by talking to the block chain directly—e.g., like any registered Ethereum accounts can use client software (block chain wallets, and such) to interact with a Dapp deployed on Ethereum.

In some embodiments, connectivity to the block chain is consistent. However, in some embodiments, depending on the deployment situations and architecture involved, solutions may have to deal with situations of intermittent connectivity at edge locations. In such cases, multiple layered block chains—e.g., edge block chains handling the solution at their own location, and periodically synchronizing up to a cloud or data center based block chain for overall recording of transactions—may be used.

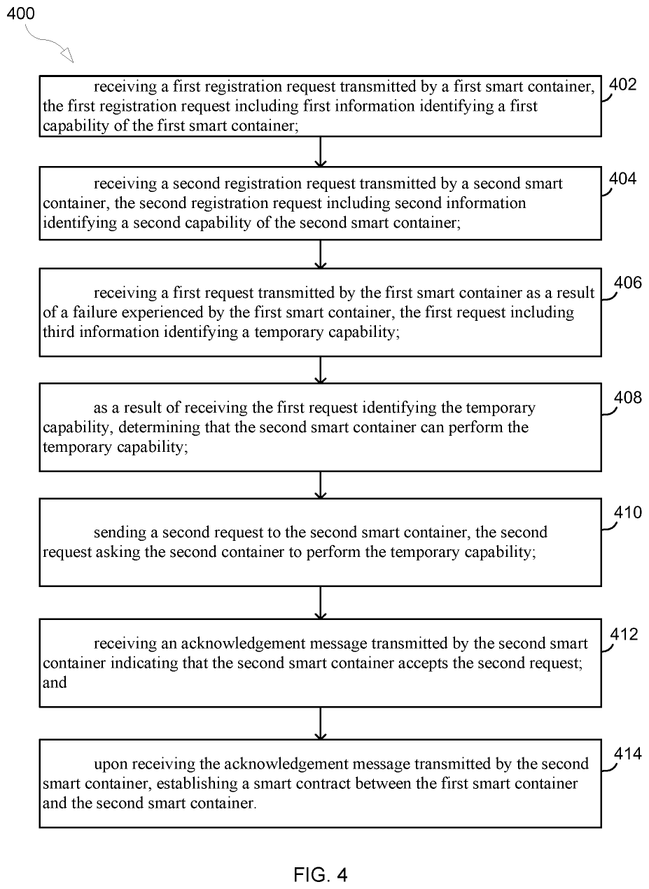

FIG. 4 illustrates a flow chart according to one embodiment. Process 400 includes receiving a first registration request transmitted by a first smart container 102, the first registration request including first information identifying a first capability of the first smart container 102 (step 402). The process further includes receiving a second registration request transmitted by a second smart container 102, the second registration request including second information identifying a second capability of the second smart container 102 (step 404). The process further includes receiving a first request transmitted by the first smart container 102 as a result of a failure experienced by the first smart container 102, the first request including third information identifying a temporary capability (step 406). The process further includes, as a result of receiving the first request identifying the temporary capability, determining that the second smart container 102 can perform the temporary capability (step 408) and sending a second request to the second smart container 102, the second request asking the second container 102 to perform the temporary capability (step 410). The process further includes receiving an acknowledgement message transmitted by the second smart container 102 indicating that the second smart container 102 accepts the second request (step 412); and upon receiving the acknowledgement message transmitted by the second smart container 102, establishing a smart contract between the first smart container 102 and the second smart container 102 (step 414).

In some embodiments, establishing a smart contract between the first smart container 102 and the second smart container 102 may encompass establishing a smart contract between the entities owning the first smart container 102 and the second smart container 102.

In some embodiments, the process may further include receiving a fulfillment message transmitted by the second container 102 indicating that the temporary capability has been performed; and upon receiving the fulfillment message, verifying the smart contract has been satisfied. In embodiments, the process may further include providing a proxy node. The method steps may be performed by the proxy node in communication with a block chain. In other embodiments, there is a block chain and the method steps are performed by the block chain. In embodiments, determining that the second smart container 102 can perform the first request for the temporary capability includes receiving first and second bids transmitted by one or more of the second smart container 102 and a third smart container 102; and selecting the second smart container 102 based on one or more of a nearest-location algorithm, a lowest-bid algorithm, a common-operator algorithm, and a max-path-alignment algorithm.

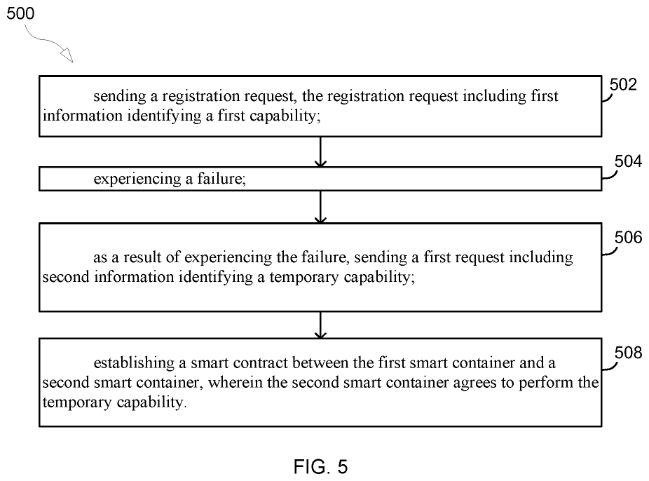

FIG. 5 illustrates a flow chart according to one embodiment. Process 500 may be performed by a first smart container 102, and includes sending a registration request, the registration request including first information identifying a first capability (step 502). The process further includes experiencing a failure (step 504); and, as a result of experiencing the failure, sending a first request including second information identifying a temporary capability (step 506). The process further includes establishing a smart contract between the first smart container 102 and a second smart container 102, wherein the second smart container 102 agrees to perform the temporary capability (step 508).

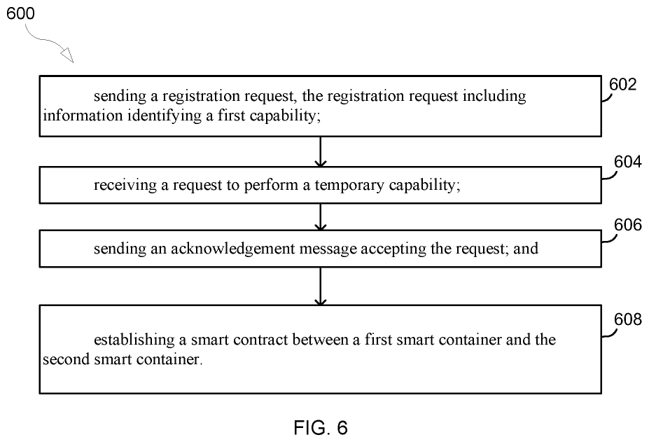

FIG. 6 illustrates a flow chart according to one embodiment. Process 600 may be performed by a second smart container 102 and includes sending a registration request, the registration request including information identifying a first capability (step 602). The process further includes receiving a request to perform a temporary capability (step 604); sending an acknowledgement message accepting the request (step 606); and establishing a smart contract between a first smart container 102 and the second smart container 102 (step 608).

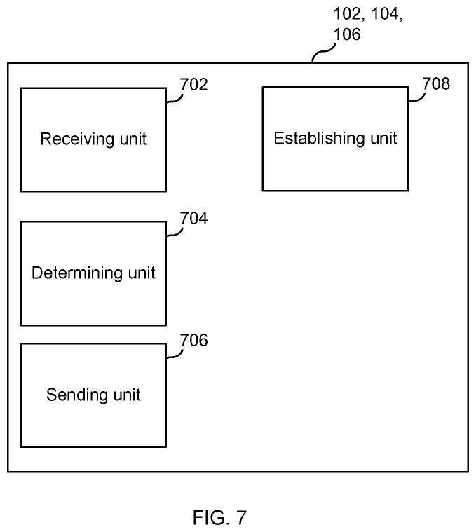

FIG. 7 is a diagram showing functional units of a node such as smart container 102, node 104, and/or ledger 106, according to some embodiments. The node includes one or more of a receiving unit 702, a determining unit 704, a sending unit 706, and an establishing unit 708.

In one embodiment, the receiving unit 702 is configured to receive a first registration request transmitted by a first smart container 102, the first registration request including first information identifying a first capability of the first smart container 102. The receiving unit 702 is further configured to receive a second registration request transmitted by a second smart container 102, the second registration request including second information identifying a second capability of the second smart container 102. The receiving unit 702 is further configured to receive a first request transmitted by the first smart container 102 as a result of a failure experienced by the first smart container 102, the first request including third information identifying a temporary capability. The determining unit 704 is configured, as a result of the receiving unit 702 receiving the first request identifying the temporary capability, to determine that the second smart container 102 can perform the temporary capability. The sending unit 706 is configured to send a second request to the second smart container 102, the second request asking the second container 102 to perform the temporary capability. The receiving unit 702 is further configured to receive an acknowledgement message transmitted by the second smart container 102 indicating that the second smart container 102 accepts the second request (step 412). The establishing unit 708 is configured, upon the receiving unit 702 receiving the acknowledgement message transmitted by the second smart container 102, to establish a smart contract between the first smart container 102 and the second smart container 102.

In another embodiment, sending unit 706 is configured to send a registration request, the registration request including first information identifying a first capability. The sending unit 706 is further configured, as a result of experiencing a failure, to send a first request including second information identifying a temporary capability. The establishing unit 708 is configured to establish a smart contract between the first smart container 102 and a second smart container 102, wherein the second smart container 102 agrees to perform the temporary capability.

In another embodiment, sending unit 706 is configured to send a registration request, the registration request including information identifying a first capability. The receiving unit 704 is configured to receive a request to perform a temporary capability. The sending unit 706 is further configured to send an acknowledgement message accepting the request. The establishing unit 708 is configured to establish a smart contract between a first smart container 102 and the second smart container 102.

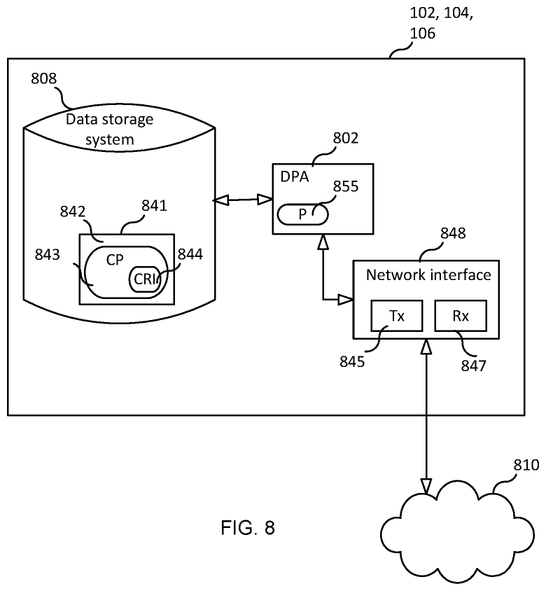

FIG. 8 is a block diagram of a node such as smart container 102, node 104, and/or ledger 106, according to some embodiments. As shown in FIG. 8, the node may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like); a network interface 848 comprising a transmitter (Tx) 845 and a receiver (Rx) 847 for enabling the node to transmit data to and receive data from other nodes connected to a network 810 (e.g., an Internet Protocol (IP) network) to which network interface 848 is connected; and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes the node to perform steps described herein (e.g., steps described herein with reference to the flow charts). In other embodiments, the node may be configured to perform steps described herein without the need for code. That is, for example, PC 802 may consist merely of one or more ASICs. Hence, the features of the embodiments described herein may be implemented in hardware and/or software.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method comprising:
receiving a first registration request transmitted by a first smart container, the first registration request including first information identifying a first capability of the first smart container;
receiving a second registration request transmitted by a second smart container, the second registration request including second information identifying a second capability of the second smart container;
receiving a first request transmitted by the first smart container as a result of a failure experienced by the first smart container, the first request including third information identifying a temporary capability;
as a result of receiving the first request identifying the temporary capability, determining that the second smart container can perform the temporary capability;
sending a second request to the second smart container, the second request asking the second smart container to perform the temporary capability;
receiving an acknowledgement message transmitted by the second smart container indicating that the second smart container accepts the second request; and
upon receiving the acknowledgement message transmitted by the second smart container, establishing a smart contract between the first smart container and the second smart container.

2. The method of claim 1, further comprising:
receiving a fulfillment message transmitted by the second container indicating that the temporary capability has been performed; and
upon receiving the fulfillment message, verifying the smart contract has been satisfied.

3. The method of claim 1, further comprising providing a proxy node, wherein the method steps are performed by the proxy node in communication with a block chain.

4. The method of claim 1, further comprising a block chain, wherein the method steps are performed by the block chain.

5. The method of claim 1, wherein determining that the second smart container can perform the first request for the temporary capability comprises:
receiving first and second bids transmitted by one or more of the second smart container and a third smart container; and
selecting the second smart container based on one or more of a nearest-location algorithm, a lowest-bid algorithm, a common-operator algorithm, and a max-path-alignment algorithm.

6. A method performed by a first smart container, the method comprising:
sending a registration request, the registration request including first information identifying a first capability;
experiencing a failure;
as a result of experiencing the failure, sending a first request including second information identifying a temporary capability; and
establishing a smart contract between the first smart container and a second smart container, wherein the second smart containers agrees to perform the temporary capability.

7. A method performed by a second smart container, the method comprising:
sending a registration request, the registration request including information identifying a first capability;
receiving a request to perform a temporary capability;
sending an acknowledgement message accepting the request; and
establishing a smart contract between a first smart container and the second smart container.

8. A device, the device comprising:
memory; and
processing circuitry coupled to the memory, wherein the device is configured to perform the method of claim 1.

9. A device, the device comprising:
memory; and
processing circuitry coupled to the memory, wherein the device is configured to perform the method of claim 6.

10. A device adapted to, the device comprising:
memory; and
processing circuitry coupled to the memory, wherein the device is configured to perform the method of claim 7.

11-13. (canceled)

14. A computer program product comprising a non-transitory computer readable medium storing instructions which, when executed on at least one processor, causes the at least one processor to carry out the method of claim 1.

15. A computer program product comprising a non-transitory computer readable medium storing instructions which, when executed on at least one processor, causes the at least one processor to carry out the method of claim 6.

16. A computer program product comprising a non-transitory computer readable medium storing instructions which, when executed on at least one processor, causes the at least one processor to carry out the method of claim 7.

17. The device of claim 8, being further configured to verify the smart contract has been satisfied upon receiving a fulfillment message transmitted by the second container indicating that the temporary capability has been performed.

18. The device of claim 8, wherein the device is configured to determine whether the second smart container can perform the first request for the temporary capability by performing a process that comprises:
receiving first and second bids transmitted by one or more of the second smart container and a third smart container; and
selecting the second smart container based on one or more of a nearest-location algorithm, a lowest-bid algorithm, a common-operator algorithm, and a max-path-alignment algorithm.
